(19) United States
(12) Patent Application Publication
(10) Pub. No.: US 2008/0073331 A1
(43) Pub. Date: Mar. 27, 2008

(54) Wire Spool Brake

(76) Inventor: Ralf Schafer, Bundesrepublik (DK)

Correspondence Address: Blakely Sokoloff Taylor & Zafman, 12400 Wilshire Boulevard, 7th Floor, Los Angeles, CA, 90025, US

(21) Appl. No.: 11/632,427

(22) PCT Filed: Apr. 19, 2006
(86) PCT No.: PCT/EP06/03558

§ 371 Date: Jan. 11, 2007

(30) Foreign Application Priority Data
Apr. 26, 2005 (DE) 10 2005 019 662.5

(51) Int. Cl. B23K 9/133; B65H 59/04

(52) U.S. Cl. 219/137.7; 242/422.5

(57) ABSTRACT

The invention relates to a braking device (12), for a wire spool (13) on an arc welding torch (10), provided with a holder (40) hinged on a support (14) and braking means (42) arranged to pivot thereon. The wire spool typically comprises a winding region (32) for winding up the wire electrode and spool edges (34, 50) extending radially above the same. The braking means (42) are particularly embodied to exert a frictional force on the spool edges (34, 50) whilst a retaining device (30) is provided in the winding region (32) to retain the wire electrode winding radially inwards.

The present invention relates to a braking device for wire spools on arc welding torches, particularly on small spool welding torches.

### TECHNOLOGICAL BACKGROUND

Arc welding torches typically comprise a feeding device for feeding a metal electrode melting during welding. It is typically wound on a replaceable spool and fed to the contact tip by means of the feeding device.

Particularly when interrupting the welding operation, care must be taken that the welding wire cannot automatically unwind from the wire spool. During welding operation, the wire feeding device applies a tensile force on the wound wire electrode, as a result of which the wire electrode spool starts to rotate. Particularly when interrupting the welding operation and during the associated stopping of the feeding device, care must be taken that the spool has no significant movement that would result in the automatic and uncontrolled unwinding of the wire electrode. For this purpose, wire spool brakes are used.

### PRIOR ART

U.S. Pat. No. 6,064,036 already describes a spool brake comprising a spring-biased arm, the free end of which comes in contact with the lateral limit of the spool body and thus applies a frictional force on the spool. On the braking mechanisms, the arm therefore only acts upon the spool edge and cannot prevent lateral migration of the outer spool windings when winding the electrode from the spool body.

According to U.S. Pat. No. 6,064,036 it is provided that the brake mechanism acts directly upon the spool windings of the spool body.

Due to the direct contact of the arm with the wire spool windings, however, the windings are continuously exposed to mechanical stress by the free end of the arm, which can have a disadvantageous effect on the properties of the wire electrode.

Furthermore, the spring-biased arm assumes a contact angle that is dependent upon the radial expansion of the spool winding because the arm acts directly upon the wire electrode windings. Since the contact angle changes as the wire electrode unwinds, this process is associated with quite a significant change in the frictional force applied on the spool windings, so that the braking force applied by the arm on the spool body is subject to changes with the continuous unwinding of the wire electrode.

Furthermore, an unwinding frame comprising a fixed arm for wire winding machines is known from DE 582 747 C. The arm here serves as support for lever bearings, of which levers one, being a braking lever, with a brake shoe disposed at the bottom end drags across a brake disk upon rotation of a supply roll. The free end of the other arm turns into a fork, on which a roller is supported. This roller rolls on the wire windings of the supply roll.

Furthermore, from DE 20 55 700 A a braking device for freely rotating spools of unwinding devices is known, with a balance arm, at the top end of which an open guide ring engages with the unwinding material. A lower, shorter arm of this balance arm engages a spool, on which the material is wound, via a brake shoe. Depending on the respective operational state of the unwinding device, either the brake shoe or the guide ring are alternately in contact with the spool body and/or the spool windings. The guide ring for the unwinding material and the brake shoe are fixed in relation to each other.

Furthermore, an arc welding apparatus with a spool brake is known from U.S. Pat. No. 3,210,522. The brake is attached to a swivel part, from which a resilient arm with a lip on one side extends. This resilient arm engages an outer rim of the reel flange, producing a braking effect.

Object

By contrast, it is the object of the invention to create an improved braking device for arc welding torches, which applies a continuous and even braking effect on the wire electrode spool, while the spool operates steadily, and allows easy replacement of the spool.

### INVENTION AND ADVANTAGEOUS EFFECTS

The object is achieved with the help of a braking device according to claim 1, an arc welding torch according to claim 10 and a small spool arc welding torch according to claim 11.

Further advantageous embodiments of the invention are disclosed in the dependent claims.

The braking device according to the invention is configured to interact with a wire electrode feeding device of an arc welding torch. The arc welding torch comprises a support for a spool body, which has a winding region for winding up the wire electrode and at least one spool edge extending over a radial extension of the wire electrode windings. The wire electrode is wound in the winding region of the preferably replaceable spool body. On the support for the spool body a holder is articulated, which in turn comprises braking means for exerting a frictional force on the spool edge.

Furthermore a retaining device for the radically inwardly directed retention of the wire electrode windings in the winding region is provided, which device prevents lateral and potentially uncontrolled migration of the outer wire electrode windings. As a result, mechanical stress of the wire electrode wound in the winding region is effectively avoided.

Furthermore, particularly the braking means coming in contact with the spool edge allows a steady frictional force and hence a steady braking effect on the spool body.

The desired functionalities of the braking device, namely even braking of the spool and retention of the outer wire windings, are achieved independently from each other by two separate components, the braking means and the retaining device. The retaining device acts upon the wire windings such that lateral, uncontrolled migration of the outermost wire electrode winding is prevented, particularly if due to an interruption in the feeding of wire electrode no tensile force resulting in the unwinding of the wire electrode acts upon the wire.

According to a first embodiment of the invention, the holder is supported pivotally on the support under the action of at least a first spring element. This first spring element causes, for example, the braking means to be pressed against the spool edge, thus producing the desired braking effect on the spool body.

According to a further embodiment of the invention, the retaining device, being a rotatable roller, can be brought in contact with the radially outermost wire electrode winding under the action of a spring element. The implementation of the retaining device as a rotatable roller, which preferably extends across the entire region between the spool edges of the spool body, is particularly advantageous because it exerts a retaining function on the windings of the spool body.

The spring force acting on the retaining device may be applied either by the first spring element and/or by a further, second spring element. As a result of the roller being pressed against the winding region by the resilient force, lateral slipping, migrating or shifting of the outermost wire winding is thus effectively prevented, particularly when unwinding the wire from the spool body. The rotatable roller minimizes the mechanical stress applied on the outermost winding of the wire electrode.

According to a further embodiment of the invention, the braking means are configured to exert a pressing force on both spool edges of the spool body. At least the first spring element preferably acts between the support and the holder. This way, the necessary pressing force of the braking means on the spool edge can be generated regardless of the spring rate of the spring element and a corresponding frictional force can be exerted on the two spool edges and on the spool body.

According to a further preferred embodiment of the invention, the braking means are supported pivotably on the holder under the action of the second spring element. At least the first spring element preferably serves the exertion of a resilient force between the support and the holder, while the second spring element allows spring-supported pivoting of the braking means on the holder.

The braking device thus comprises at least two pivotable elements for exerting the frictional force on the spool edge. The braking means are typically disposed pivotably on the free end of the holder by means of the second spring element, while the holder is supported pivotably at the other end thereof on the support for the spool body of the torch under the action of at least the first spring element. The braking device according to the invention thus has at least a two-member braking arm, which due to the pivotable holder provides a relatively large adjustment range for the braking means, which is advantageous particularly with respect to the replacement of the spool body.

Furthermore it is provided that the retaining device is supported pivotably on the holder. This configuration particularly results in the fact that the retaining device is always in contact with at least the outermost wire winding, regardless of the radial extension of the winding region of the spool body. The pivotable configuration of the retaining device is important because the radial extension of the windings of the spool body continuously decreases with the constant use of the arc welding torch.

The retaining device is preferably disposed pivotably at the free end of the holder. The braking means and the retaining device can be disposed particularly on opposite sides of the holder, so that the second spring element is mechanically linked to both the braking means and the retaining device. The braking means as well as the retaining device may be pivotable about a common swivel axis or about two different swivel axes, which are preferably oriented parallel to each other. Furthermore, it may be provided that one or more separate spring elements are used for articulating the braking means on the holder and for articulating the retaining device on the holder.

The retaining device is preferably supported on the holder under the action of the second spring element, so that contact with at least the outermost wire winding is always guaranteed.

A further embodiment of the invention is such that the braking effect or the frictional force to be applied by the braking means on the spool edge is adjusted to the properties of the wire feeding device by at least one spring element. This adjustment, on the one hand, is supposed to prevent that the frictional force is impaired by the feeding device. On the other hand, the adjustment in terms of the type and kind, particularly of the spring rate of at least one spring element, ensures that always the necessary frictional force is applied on the wire electrode spool during operation of the arc welding torch. This frictional force consequently always guarantees that subsequent movement of the spool body is prevented after the torch has been shut off, or when the welding operation has been interrupted, which is associated with the stopping of the spool body and the feeding step.

According to a further preferred embodiment of the invention, the braking means are configured in a single-piece design as a plate pivotable on the free end of the holder, which plate acts as a brake shoe on both spool edges of the spool body.

Furthermore it is provided that the braking means have a contour that is adapted to the rounded shape of the spool body. As a result, the geometry of the braking means is slightly rounded, so that in the contact position with the spool edge they have the maximum contact surface to develop the maximum frictional force.

According to a further aspect, the invention relates to an arc welding torch comprising a braking device according to the invention as described above.

The braking device according to the invention is provided for use in small spool welding torches. The invention therefore also relates to small spool welding torches comprising a braking device according to the invention as described above.

### EXEMPLARY EMBODIMENT

Further objectives, advantages, characteristics and applications of the present invention will be apparent from the description of the exemplary embodiment provided hereinafter with reference to the figures. All characteristics described and/or illustrated in the figures, either alone or in any arbitrary and meaningful combination, relate to the object of the present invention, also independently of their combination in the claims or reference.

Shown are:

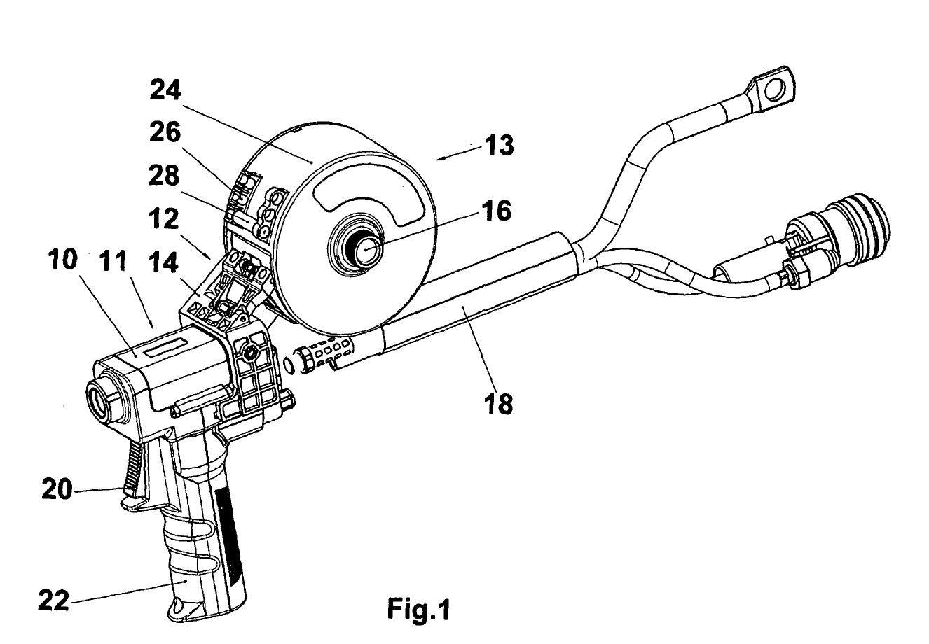

FIG. 1 is a perspective view of a small spool welding torch comprising a wire spool braking device,

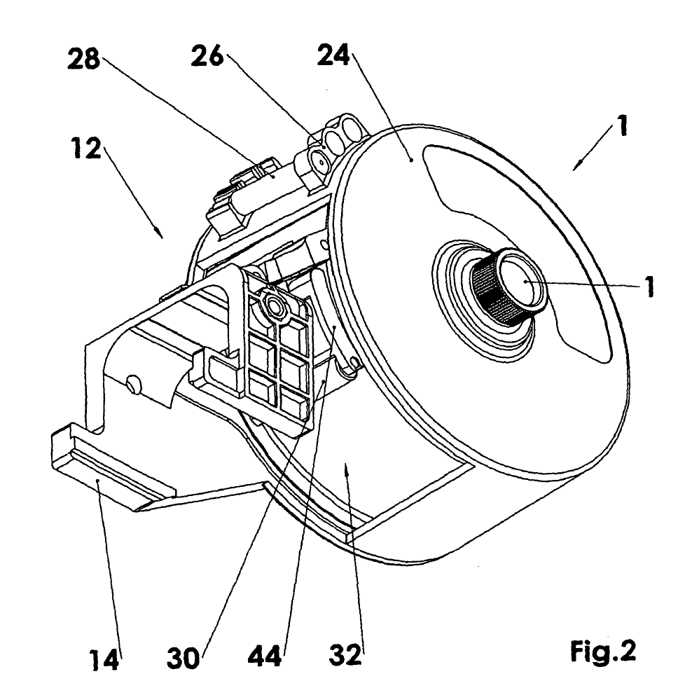

FIG. 2 is a perspective illustration of the support for the spool body,

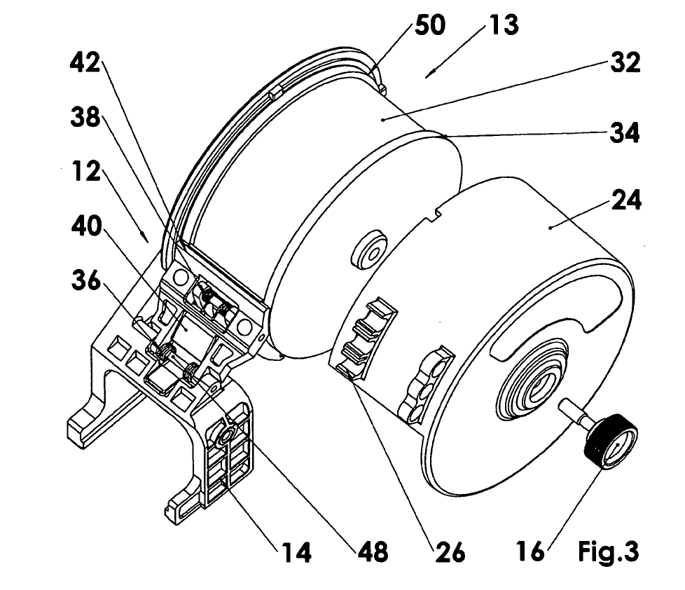

FIG. 3 is a further perspective view of the spool body support with the protective cover removed,

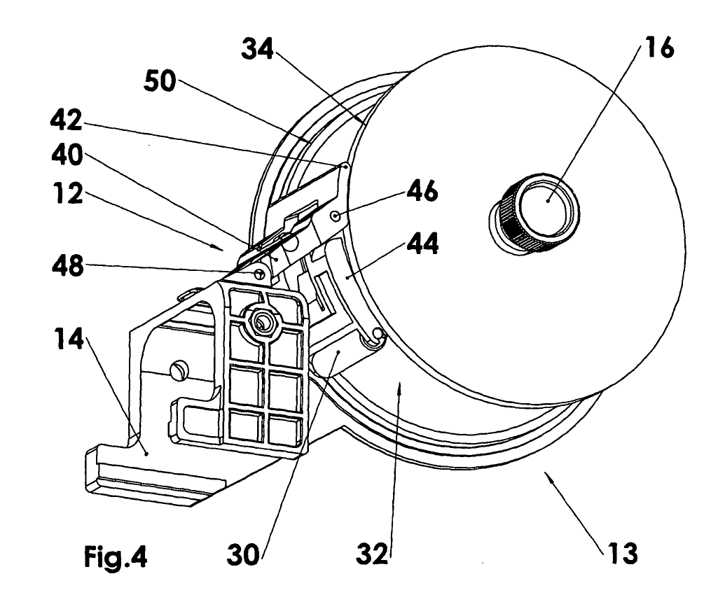

FIG. 4 is a perspective view of the braking device acting on the spool body,

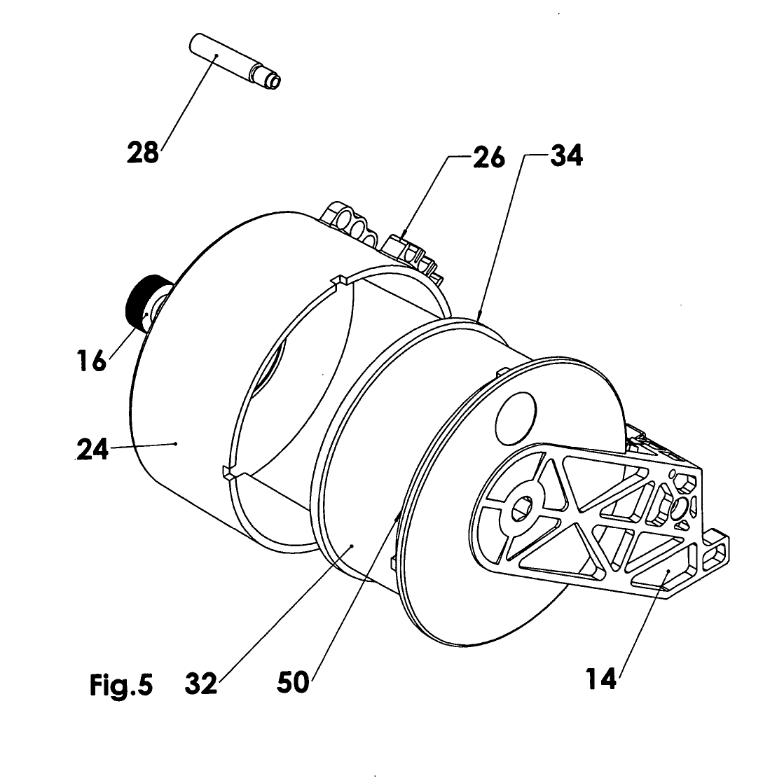

FIG. 5 is an exploded view of the spool body support with protective cover, and

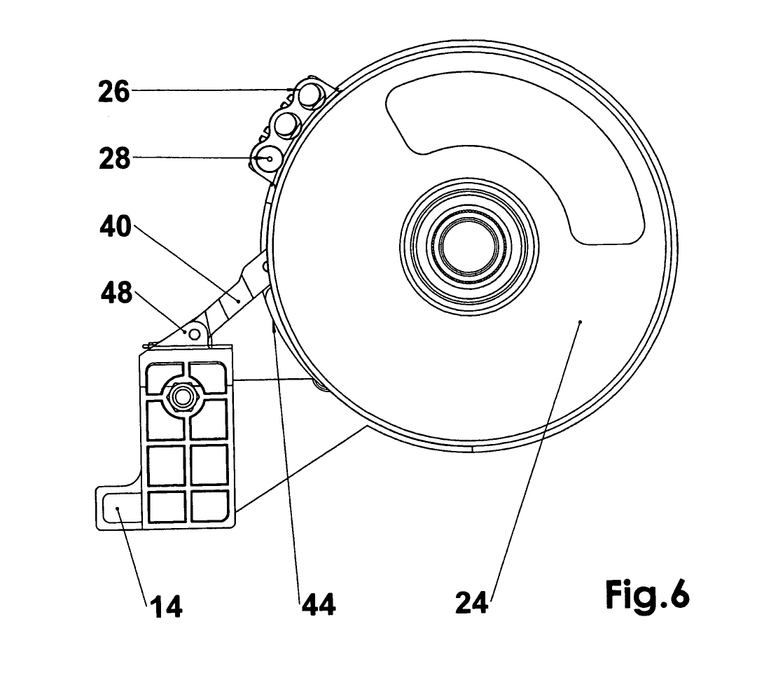

FIG. 6 is a side view of the spool body support with the braking device.

FIG. 1 shows a perspective illustration of a small spool welding torch 10, which comprises a spool body 13 attached via a spool support 14. In the region of a fastening screw 16, the spool body 13 can be slid on an axis that is attached to the spool support 14. Furthermore, the spool body 13 is covered by means of a protective cover 24.

The small spool welding torch 10 furthermore has an actuating element 20 in the region of the grip 22 for starting up the torch and controlling the welding operation. In particular, it is provided that upon actuation of the actuating element 20 configured as a button or rocker switch the feed 11 driven by an electric motor for the wire electrode is activated and the wire electrode is wound off the spool body 13 by the feeding device.

The small spool welding torch 10 is furthermore configured for the connection to a supply line 18, which ensures the supply with power and/or protective gases.

The protective cover 24 of the spool body 13 furthermore comprises a mount 26, which serves the accommodation of potential replacement contact tips 28.

FIG. 2 shows a perspective illustration of the spool body support 14 from underneath in a state disassembled from the small spool welding torch 10. The spool body support 14 may be placed from the back on the small spool welding torch 10, for example, and optionally be screwed thereto. The protective cover 24 serves as a cover for the spool body 13 held by the spool support 14. Particularly in the region of the braking device 12, the protective cover 24 is not configured continuously, so that the braking device 12 can act directly on the spool body 13. It is preferable if the protective cover 24 on the bottom, meaning the side facing the supply line 18, exposes the windings 32 of the wire electrode wound on the spool body 13.

FIG. 2 to some extent furthermore shows the retaining device configured as a pressure roller 30, which counteracts the migration, lateral shifting or the like of the outermost wire winding across the entire width of the winding region 32 of the spool body 13.

FIG. 3 shows a perspective view of the spool support 14 with the spool body 13 disposed thereon in an exploded view, in which a disassembled protective cover 24 exposes the braking device 12 interacting with the spool body 13. It is clearly evident that the spool body 13 has a winding region 32, which abuts a spool edge 34, 50 on the side. The radial extension of the spool edge or of the front disks 34, 50 thereof exceeds the radial extension of the windings in the winding region 32.

The plate-shaped braking element 42 of the braking device 12 is thus in a contact position with the spool edge 34, 50 and exerts a frictional force on the spool edge 34, 50 via the spring element 36 and the holder 40. As a result, when operating the torch a steady braking effect on the spool edge 34, 50 and thus on the entire spool body 13 is guaranteed.

The braking device 12 may also have a two-member design. The holder 40 is disposed pivotably on the support 14 on a first swivel axis 48 under the action of the resilient force of the spring element 36. Similarly, the braking element 42 configured as a brake shoe is disposed pivotably on the holder via the swivel axis 46 and by means of the spring element 38.

This way, direct action of the braking device 12 on the spool edge 34, 50 is achieved. In addition, the two pivotable mounts for the support 40 and the braking element 42 basically allow spool bodies 13 with different diameters to be attached to the support 14. The braking element 42 is always brought in contact with the spool edge 34, 50 by means of the first spring element 36 and the holder 40.

FIG. 4 shows a further perspective illustration of the holder 14 with the protective cover 24 removed. Particularly the two swivel axes 48, 46 can be seen, on which the holder 40 is articulated on the support 14 and the braking element 42 is supported pivotably on the holder 40. Furthermore, FIG. 4 shows the retaining element 44 extending in the opposite direction of the braking element 42, on the free end of which retaining element the retaining roller 30 is seated. It is preferable if the retaining element 44 can interact with the outermost winding 32 of the wound wire electrode by means of the second spring element 38.

The pivotable support of the holder 40 about the swivel axis 48 furthermore allows the entire braking mechanism to fold away from the spool body 13. This facilitates particularly the replacement of the spool body 13. The configuration of the free end of the retaining element 44 as a rotatable roller 30 offers the advantage that a lateral movement of the outermost spool windings and a potentially associated migration of the outermost spool winding are effectively prevented.

The braking element configured as a brake shoe 42, on the other hand, only acts on the spool edges 34, 50 delimiting the winding region 32, the radial extension of which edges remains constant when unwinding the windings 32, so that a constant braking effect of the braking device 12 is guaranteed at all times. Furthermore, the braking element 42 has a slightly rounded shape that is adapted to the radius of the wire spool edge 34, 50 so as to form the maximum possible frictional surface with the wire spool edge 34, 50.

FIG. 5 shows an exploded view of the spool body support 14 corresponding to FIG. 3, which support comprises a spool body 13 attached thereto, with a disassembled protective cover 24. In addition, a replacement contact tip 28 is shown here, which may be held on the mount 26 disposed on the outer wall of the protective cover 24. In this view, particularly the side of the spool support 14 leading to the axis of the spool body 13 can be seen.

FIG. 6 furthermore shows a side view of the spool body support 14 with the braking device 12, comprising the holder 40 and the braking element 42. The braking element 42 extending substantially in an azimuthal direction as well as the retaining element 44 are only shown to some extent here.

### LIST OF REFERENCE NUMERALS

10 Arc Welding Torch, Small Spool Welding Torch
11 Feeding Device
12 Braking Device
13 Spool Body
14 Spool Support
16 Fastening Screw
18 Supply Line
20 Actuating Means
22 Handle
24 Protective Cover
26 Mount
28 Contact Tip
30 Retaining Device, Retaining Roller
32 Wire Winding
34 Wire Spool Edge
36 Spring Element
38 Spring Element
40 Holder
42 Braking Element
44 Retaining Element
46 Swivel Axis
48 Swivel Axis
50 Wire Spool Edge

1. A braking device for a wire electrode feeding device (11) of an arc welding torch (10), comprising a support (14) for a spool body (13) with a winding region (32) for winding up the wire electrode and at least one spool edge (34, 50) extending over the radial extension of the wire electrode windings, characterized in that a holder (40) is articulated on the support (14), on which holder in turn braking means (42) assuming a contact position with the spool edge (34, 50) for exerting a frictional force and a retaining device (30) for retaining the wire electrode windings radially inward are provided in the winding region (32).

2. The braking device according to claim 1, characterized in that the holder (40) is supported pivotably on the support (14) under the action of at least a first spring element (36).

3. The braking device according to claim 1 or 2, characterized in that the retaining device is configured as a rotatable roller (30), which can be brought in contact with the radially outermost wire electrode winding under the action of a spring element (36, 38).

4. A braking according to any one of the claims 1 to 3, characterized in that the retaining device can be brought in contact with the radially outermost wire electrode winding under the action of a second spring element (38).

5. A braking device according to claim 1 or 4, characterized in that the braking means (42) are configured for exerting a braking force on both spool edges (34, 50).

6. A braking device according to any one of the claims 1 to 5, characterized in that the braking means (42) are supported pivotably on the holder (40).

7. A braking device according to any one of the claims 1 to 6, characterized in that the retaining device (30) is supported pivotably on the holder (40).

8. A braking device according to any one of the claims 1 to 7, characterized in that the frictional force, which can be exerted on at least one spool edge (34, 50) by the braking means (42), is adjusted to the wire feeding device (11) by means of the first and/or second spring elements (36, 38).

9. A braking device according to any one of the claims 1 to 8, characterized in that the braking means (42) have a single-piece design in the form of a plate.

10. A braking device according to any one of the claims 1 to 9, characterized in that the braking means (42) have a contour that is adapted to the rounded shape of the spool body (13).

11. A gas-shielded arc welding torch comprising a braking device (12) for a wire electrode feeding device (11) according to any one of the claims 1 to 10.

12. A small spool welding torch comprising a braking device (12) for a wire electrode feeding device (11) according to any one of the claims 1 to 10.
